(19) United States
(12) Patent Application Publication
(10) Pub. No.: US 2025/0131198 A1
(43) Pub. Date: Apr. 24, 2025

(54) System and Method for Automated Stance Detection

(71) Applicant: Advanced Symbolics (2015) Inc., Ottawa (CA)

(72) Inventors: Kenton White, Ottawa (CA); Shainene Davidson, Ottawa (CA)

(21) Appl. No.: 18/921,170

(22) Filed: Oct. 21, 2024

Related U.S. Application Data
(60) Provisional application No. 63/591,785, filed on Oct. 20, 2023.

(51) Int. Cl. G06F 40/30; G06F 16/33

(52) U.S. Cl. CPC G06F 40/30; G06F 16/3344

(57) ABSTRACT

A method for determining stance includes providing a stance topic to be evaluated. Based on the stance topic, a first query is determined reflective of the stance topic. A second other query is determined converse to the first query. The first query and the second other query are then evaluated against content to determine stance results of said content and the determined stance results are then statistically combined to determine stance.

### FIELD OF THE INVENTION

The invention relates to semantic analysis and more particularly to a method and system for stance detection within a short message.

### BACKGROUND

Bias is a common problem in all areas of communication. An area that is prone to the effects of bias is artificial intelligence (AI). In fact, bias that is undetected can result in trained Al models suffering significant and overt bias due to the nature of human communications. Many forms of bias are subtle and difficult to detect; that said, many forms of bias are well understood by people and are automatically filtered out in human data gathering.

The first problem in bias determination is determining a stance of a piece of content. A stance is a position or general bias of the content; the stance is not subtle or hidden, it is intended to be communicated through the content or as part of the response to the content. Thus, an article about a dictator that refers to them as a tyrant and derides their leadership has a stance that is against the tyrant. A similar article about a tyrant that promotes their views and their accomplishments would have a stance that is supportive of a tyrant. In many pieces of content, different stances can be seen with relation to different issues or different topics.

A major challenge in stance detection is detecting stance in short, written content. For example, a tweet is a short, written statement and, as such, determining stance in a tweet can be challenging. Even when taken in context of a stream of tweets, some stances are not immediately evident to semantic analysis. For automated large scale semantic training models, errors in stance evaluation can translate into inadvertent but significant trained biases.

For example, in a stream of Twitter® tweets about a Presidential candidate, some tweets are evidently for the candidate, “I like Candidate A.” Other tweets are evidently against the candidate, “I don't like Candidate A.” But many tweets are ambiguous and some may even be statistically informative, but not evident. For example, the tweet, “I like Candidate B” does not preclude liking Candidate A, though it may suggest a preference for Candidate B. It gets more confusing when, for example, within the stream someone says, “What if Candidate A were not running?” leaving the following tweets to be disambiguated between generalised statements and statements within that context, which might be generalised and might be specific to context. The statement, “I like Candidate B” made after the statement, “What if Candidate A were not running?” could mean that I like Candidate B if A is not running or could mean that I like Candidate B regardless. Thus, semantic analysis is complex and difficult and stance detection is even moreso.

The problem of semantic analysis extends further to less clear tweets. Sometimes, a short written message that is clearly of a particular stance when read by people, is ambiguous when analysed with semantic analysis.

It would be advantageous to provide a method and system for overcoming at least some aspects of the shortcomings of the prior art semantic analysis.

### SUMMARY OF EMBODIMENTS OF THE INVENTION

In accordance with an embodiment there is provided a method comprising: providing a stance to be determined; determining a first query indicative of the stance; determining a second other query indicative of a converse of the stance; processing semantic analysis of stance for the first query to produce first results; processing semantic analysis of stance for the second other query to produce second results; and statistically combining the first results and the second results to determine the stance.

In accordance with an embodiment there is provided a method comprising: providing a first stance to be determined; determining a first query indicative of the first stance; determining a second other query indicative of a second different stance having a known statistical relation to the first stance; and processing semantic analysis to determine stance for the first query to provide first results; processing semantic analysis to determine stance for the second other query to provide second results; and statistically combining the first results and the second results to determine stance within a piece of content.

In some embodiments, the method comprises determining a third other query indicative of a third different stance having a known statistical relation to the first stance; and processing semantic analysis to determine stance for the third other query to provide third results, wherein statistically combining is performed to statistically combine the first results, the second results and the third results to determine stance within a piece of content.

In accordance with an embodiment there is provided a method comprising: providing a first query indicative of a stance to be determined; determining a second other query related to the stance, a measurement of the a response to the second query statistically indicative of at least some measure of the stance; processing semantic analysis of stance for the first query to produce first results; processing semantic analysis of stance for the second other query to produce second results; and statistically combining the first results and the second results to determine the stance.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified flow diagram of a prior art stance determination.

FIG. 2 is a simplified flow diagram of an improved stance detection process for determining stance.

FIG. 3 is a simplified flow diagram of an improved stance detection process for determining stance based on a first query and a second other query approximately converse to the first query.

FIG. 4 is a simplified flow diagram of a method of automatically retrieving queries relating to an initial query or hypothesis having a known structure, such as who is likely to win an upcoming presidential election.

FIG. 5 is a simplified flow diagram of a method of automatically retrieving queries relating directly to an initial query or hypothesis having a known structure and queries relating to related topics relating to the query or hypothesis; an exemplary question is who is likely to win an upcoming presidential election.

FIG. 6 is a simplified flow diagram of a method of providing data for use in query generation.

FIG. 7 is a simplified flow diagram of a method of determining stance as having an amplitude and direction.

FIG. 8 is a simplified flow diagram for representing stance as a graph of stance value over time.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

‘against’ is used herein and in the claims that follow to indicate a bias or stance relative to a query or statement; ‘against’ as used herein refers to a negative response to a query or a stance against a statement or hypothesis.

Artificial Intelligence (AI) refers to correlation processing relying on training to produce a model, the model relied upon to correlate input values to output values.

Artificial Intelligence (AI) model is a model formed by training an artificial intelligence system with input data and known output data relating to the input data. Training the artificial intelligence system results in a dataset for correlating input data to output data, the dataset forms the artificial intelligence model.

Automatically trained models are artificial intelligence models that are trained through an automated process, either with updated information provided over time or with automated data analysis used to estimate output values for a given input value.

Bias refers to a statistical closeness or distance from a given statement within a piece of content. Bias includes unrecognised bias, such as repeating untrue but believable tropes that are associated with a position on an issue, recognised unintentional bias such as using adjectives indicative of a position on an issue, and intentional bias such as stating a position on an issue. In evaluating bias, bias can also have an intensity such that some content is indicative of agreement or disagreement with a given statement while other content simply leans toward or away from the statement.

Converse query is used herein to refer to a query that is related to the hypothesis in a somewhat inverse fashion. For example, prefers coke to pepsi has a converse query of prefers Pepsi to Coke. That said, oftentimes converse queries are only approximately converse a hypothesis due to other options or information. For example, likes Pepsi might be seen as converse to likes Coke, but in fact there are many soft drink options beyond Coke and Pepsi. Similarly, in political questions liking a candidate is usually evaluated against likely successful candidates and outliers are often not even considered.

‘for’ is used herein and in the claims that follow to indicate a bias or stance relative to a query or statement; ‘for as used herein refers to a positive response to a query or a stance for a statement or hypothesis.

Statistically combine refers to a combination of values that is determined statistically so as to reflect some information sought through said combination. For example, averaging is a statistical combination of values as is summation.

Semantic analysis is a process wherein words and phrases are analysed to extract information form content. For example, semantic analysis is useful to read text and determine what the text intends to say.

Stance refers to a position indicated by bias within content. For example, stance is a position stated within the piece of content; alternatively, stance is a position determinable from the piece of content that is not stated therein. Further alternatively, stance is estimable but not easily measured or detected.

Stance direction indicates a lean or bias-for or against-in a stance regardless of how much the lean or bias is for or against.

Stance strength indicates how much lean or how biased in a stance direction a measured stance is. For example, a stance that does not condemn a position is less strong than a stance that supports the same position.

Training is a process in design and implementation of correlation engines wherein the engine is presented with input data and known output data for the input data. From the known output data and from the input data, the correlation engine forms a model that is used in correlating newly provided input data to output data.

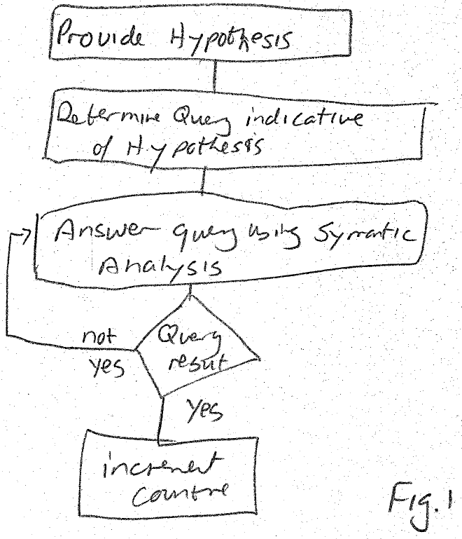

Referring to FIG. 1, shown is a simplified flow diagram of a method of stance detection according to the prior art. Here, a simple query is asked equivalent to testing a hypothesis. For example, do Twitter® users who follow Kendall Jenner like Pepsi®. The system then analyses tweets from each user who follows Kendall Jenner and looks for indications that they like Pepsi®. For example, every tweet that mentions Pepsi® is evaluated for stance in the form of-does the individual like Pepsi®. Simply adding all tweets that like Pepsi results in a score that is indicative of how the group likes Pepsi®.

As noted above, this is a problematic approach to answering the question, because many positive tone statements are not determinative of a real-world stance and many statements are contextual and not related to a stance on the question asked. Further, accurate determination of tone within a short text message is difficult when relying on semantic analysis.

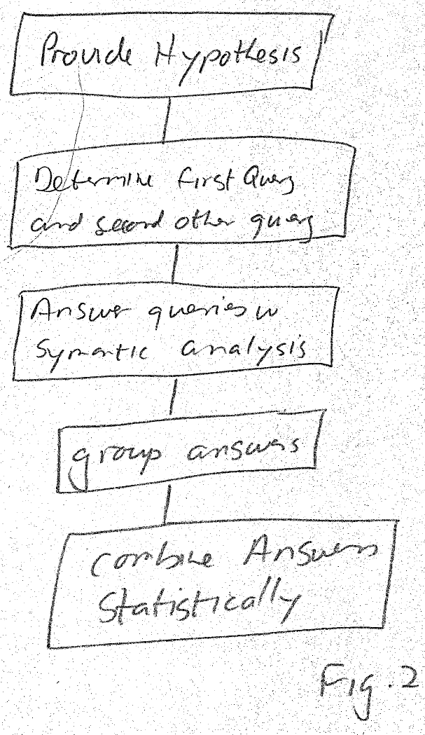

Referring to FIG. 2, shown is a stance detection process that is improved over the prior art. Here, a hypothesis is provided; for example, “Do the followers of Kendall Jenner prefer Pepsi?” The hypothesis is then broken down into a series of questions, presenting different stances that relate to the hypothesis. In FIG. 2, the questions are shown as the following:
Do the followers of Kendall Jenner like Pepsi?
Do the followers of Kendall Jenner dislike Pepsi?

As the semantic analysis process will be automated, including more questions requires additional processing resources, but not significantly more user time. Once a series of relevant and inter-related queries is provided, the semantic analysis process evaluates each posting within a stream of social media data from relevant users to extract specific scores relating to each question and then statistically combines the scores to determine a stance of a particular user or group. Thus a single user may show as follows:
Likes Pepsi: 87 posts
Dislikes Pepsi: 23 posts
Alternatively, the single user result shows as “Prefers Pepsi.”

In an embodiment, each post is evaluated for each question and results of evaluation are then combined statistically to create a stance estimation for the post. In another embodiment, results for each user across all posts are statistically combined to form an estimation of the user stance. In yet a further embodiment, results for all posts and all users are statistically combined to estimate an overall result for the hypothesis. Of course, different approaches are useful in different situations and, as such, some embodiments select different ones of the above embodiments for different analyses.

In the example, relying upon the same hypothesis, another user shows as follows:
Likes Pepsi: 87
Dislikes Pepsi: 92
Alternatively, the other user might just show as “Dislikes Pepsi®.”

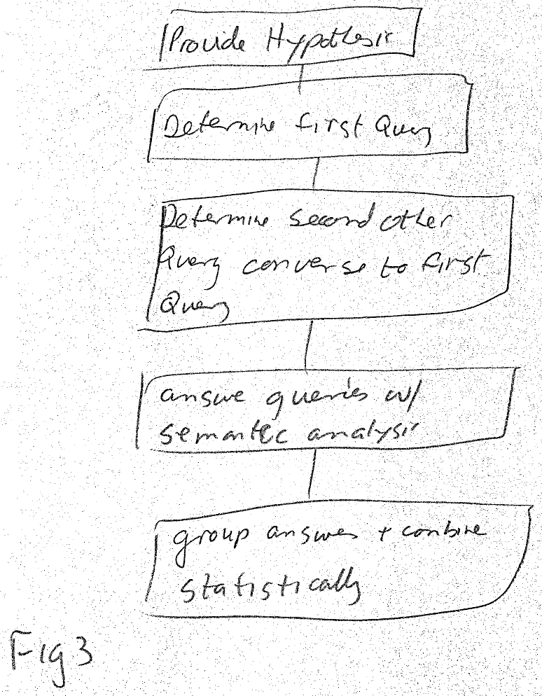

Referring to FIG. 3, shown is a stance detection process that is improved over the prior art. Here, a hypothesis is provided; for example, “Do the followers of Kendall Jenner prefer Pepsi?” The hypothesis is then broken down into a series of questions, presenting different stances that relate to the hypothesis including an approximately converse stance—“Do the followers of Kendall Jenner like Coke?”. Likely questions include the following:
Do the followers of Kendall Jenner like Pepsi?
Do the followers of Kendall Jenner dislike Pepsi?
Do the followers of Kendall Jenner like Coke?
Do the followers of Kendall Jenner dislike Coke?
Alternatively, this might be stated as follows:
Do the followers of Kendall Jenner prefer Pepsi to Coke?
Do the followers of Kendall Jenner prefer Coke to Pepsi?

As the semantic analysis process will be automated, including more questions requires additional processing resources, but not significantly more user time. Therefore, one could add questions relating to other drinks or categories of drinks. Alternatively, both sets of questions are provided to determine two scores for the same problem, each determined differently. Other related questions such as, “Are the followers of Kendall Jenner health food fanatics?” can also be included when a result is useful in the overall analysis.

The inclusion of further questions allows for alternative perspectives on the semantic analysis or, alternatively, for alternative perspectives on a measure of stance. For example, measuring health food bias in a measurement of soft drink bias might provide completely different but important stance information.

Once a series of relevant and inter-related queries is provided, the semantic analysis process evaluates each posting within a stream of social media data from relevant users to extract specific scores relating to each question and then statistically combines the scores to determine a stance of a particular user or group. Thus a single user may show as follows:
Likes Pepsi: 87 posts
Dislikes Pepsi: 23 posts
Likes Coke: 2 posts
Dislikes Coke: 0 posts
Alternatively, the single user result shows as “Prefers Pepsi.”

In an embodiment, each post is evaluated for each question and results of evaluation are then combined statistically to create a stance estimation for the post. In another embodiment, results for each user across all posts are statistically combined to form an estimation of the user stance. In yet a further embodiment, results for all posts and all users are statistically combined to estimate an overall result for the hypothesis. Of course, different approaches are useful in different situations and, as such, some embodiments select different ones of the above embodiments for different analyses.

In the example, relying upon the same hypothesis, another user shows as follows:
Likes Pepsi: 87
Dislikes Pepsi: 23
Likes Coke: 287
Dislikes Coke: 0
Alternatively, the other user might just show as “Prefers Coke.”

Relying on prior art analysis, one would conclude that both followers of Kendall Jenner prefer Pepsi® as both like Pepsi more than they dislike Pepsi. By enhancing the queries to accommodate the positive and negative questions and approximately converse positive and negative questions, stance information that was not previously noted is highlighted wherein positive statements about Pepsi made by some people are not indicative of their overall stance. Such is often the case when a great commercial receives accolades from viewers, but their stance related to the advertised product does not change to the same degree; they become more positive about the product but not enough to change a preference.

Differences in stance and voting preferences is often seen in politics where a politician's position on an issue may be viewed as much superior while still not influencing voters to choose that politician over other available choices because other issues or concerns are paramount.

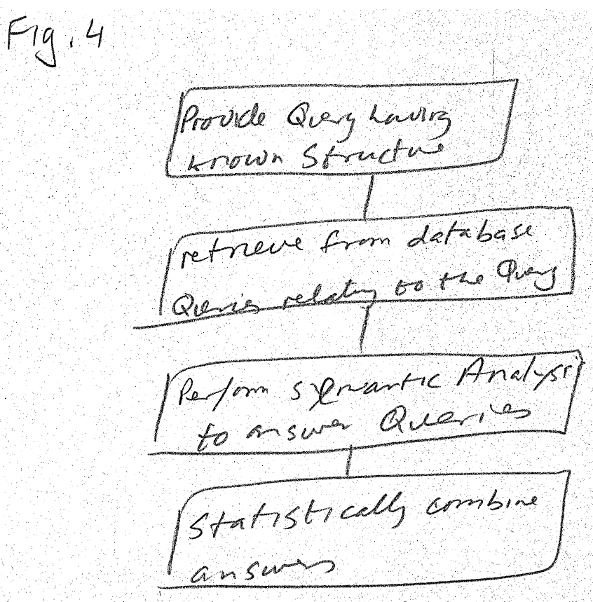

Referring to FIG. 4, shown is a simplified automated approach to the method of FIG. 3. A stance is evaluated through the introduction of a plurality of related queries. When applied to politics, for example, the process is both informative and improves overall stance detection.

Here a candidate is provided and the question is will individuals in a select group vote for that candidate. The hypothesis is that the individuals will vote for Candidate A. In Presidential races, typically the focus is on the two main candidates—Republican and Democrat—so the hypothesis leads to the question “Is Candidate A preferred over Candidate B.” That simple question is broken down into the following questions:
Is the stance ‘for’ Candidate A?
Is the stance ‘against’ Candidate A?
Is the stance ‘for’ Candidate B?
Is the stance ‘against’ Candidate B?

Of course, there are other candidates, so the generalised process evaluates a likelihood that any candidates are competitive and adds them to the queries. Here, for US presidential races, only two candidates are competitive so the four questions above cover the general information sought. Alternatively, a likelihood is provided. Then all candidates above a predetermined likelihood are included in the questions. For example, a poll is referenced and all candidates above 10% in the poll are included potentially resulting in more than two candidates. For three candidates, 6 questions result. For four candidates, it is 12 questions.

Knowing the candidates in the race and poll results allows the system to automatically generate queries and related queries in the form of approximately converse queries. Approximately converse queries include converse queries that are truly converse.

Once all queries are evaluated relying on semantic analysis, the results are statistically combined to estimate stance within the postings; for example, stance of each posting is estimated. Alternatively, stance for each individual is estimated. Further alternatively, stance for the group is estimated. In yet another alternative, stance is estimated over time establishing changes in stance for individuals or for the group.

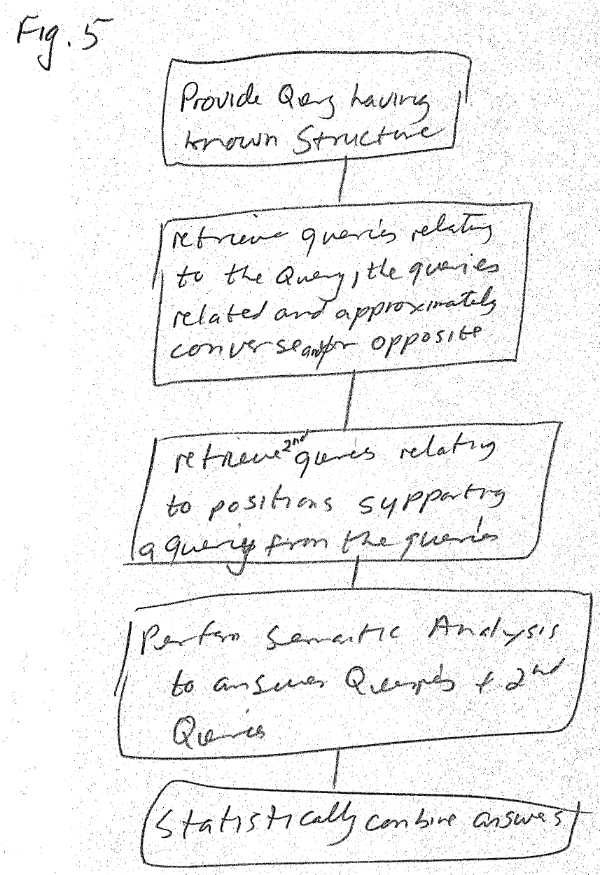

Referring to FIG. 5, shown is a simplified automated approach to the method of FIG. 3. A stance is evaluated through the introduction of a converse stance statement and issue statements aligned and misaligned with the stance statement. When applied to politics, the process is both informative and improves overall stance detection.

Here two candidates are provided and the question is “Is Candidate A preferred over Candidate B by a select group, for example the followers of Kendall Jenner?” That simple question is broken down into the following questions:
Is the stance ‘for’ Candidate A?
Is the stance ‘against’ Candidate A?
Is the stance ‘for’ Candidate B?
Is the stance ‘against’ Candidate B?
Is the stance ‘for’ Candidate A′s position on Issue A?
Is the stance ‘against’ Candidate A′s position on Issue A?
Is the stance ‘for’ Candidate B′s position on Issue A?
Is the stance ‘against’ Candidate B′s position on Issue A?

Of course, the questions optionally encompass any number of issues for which candidate opinions are known.

Once all queries are evaluated relying on semantic analysis, the results are statistically combined to estimate stance within the postings; for example, stance of each posting is estimated. Alternatively, stance for each individual is estimated. Further alternatively, stance for the group is estimated. In yet another alternative, stance is estimated over time establishing changes in stance for individuals or for the group.

Referring to FIG. 5, again, another example is presented with three candidates. Psychology has determined that people do not always evaluate three option decisions logically. A person may prefer apples to oranges and oranges to pears but still prefer pears to apples. Thus, people do not always logically decide when given three options.

This very fact makes the three-candidate example unique, because a resulting analysis of stance may also highlight certain comparative binaries that are notable.

Here, the questions generated for the hypothesis that Candidate A is preferred amongst most voters is as follows:
Is the stance ‘for’ Candidate A?
Is the stance ‘against’ Candidate A?
Is the stance ‘for’ Candidate B?
Is the stance ‘against’ Candidate B?
Is the stance ‘for’ Candidate C?
Is the stance ‘against’ Candidate C?
Is the stance ‘for’ Candidate A′s position on Issue A?
Is the stance ‘against’ Candidate A′s position on Issue A?
Is the stance ‘for’ Candidate B′s position on Issue A?
Is the stance ‘against’ Candidate B′s position on Issue A?
Is the stance ‘for’ Candidate C′s position on Issue A?
Is the stance ‘against’ Candidate C′s position on Issue A?
Is the stance ‘for’ Candidate A′s position on Issue B?
Is the stance ‘against’ Candidate A′s position on Issue B?
Is the stance ‘for’ Candidate B′s position on Issue B?
Is the stance ‘against’ Candidate B′s position on Issue B?
Is the stance ‘for’ Candidate C′s position on Issue B?
Is the stance ‘against’ Candidate C′s position on Issue B?

As is evident, the number of queries is growing as automated query generation is employed. Since automated semantic analysis is used to evaluate stance, additional queries, limited by cost and time constraints, allow for additional insights. By determining a “stance” of a single piece of content in the form of a twitter post for each question, the system allows for statistical filtering of some information and statistical amplification of others. For example, a series of posts deriding Candidate B could accrue to each of Candidates A and C differently depending on other factors. Further, such an analysis now allows for correlating between stances and issues; for example, if everyone supportive of Candidate B is also supportive of Candidate B's stance on a particular issue, then this could be a significant issue to those people. Thus, expanding the hypothesis from a simple question to two opposing questions and then to converse statements and then to related issues gives rise to a more nuanced stance detection for individual posts, for individuals, and for groups of individuals. The additional questions improve the stance detection, but they also provide alternative views into the stance data-into user opinions.

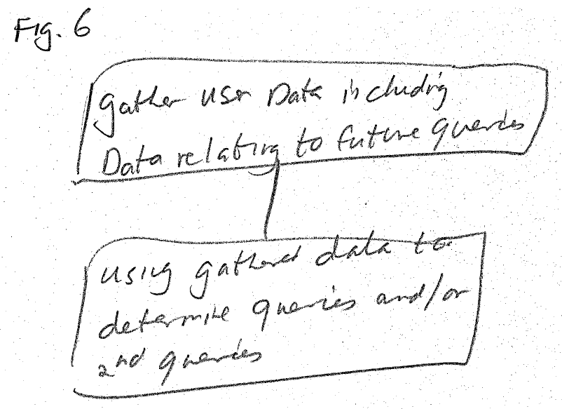

Referring to FIG. 6, shown is a method of automatically determining questions for use in stance detection. For example, questions are determined using artificial intelligence. Alternatively, a large language model is used. Further alternatively, another method of question generation is employed. The stance determining questions are determined automatically based on a priori information, for example a user is prompted to answer the following question: If the stance were not as indicated, can you tell me a statement that would likely be true. Alternatively, in some situations a priori information is provided to automate stance question and converse question determination. For example, when Pepsi sets up their account, they enter each of their products and the main competitive brands and owners for each of their products. The system can then automatically generate a converse query based on PepsiCo's perceived competitive landscape.

For example, in a political race, candidates and their parties and their position on some issues can be entered into the system to be used in stance detection. Stance on an issue would rely on which parties and which candidates are for that issue and stance on a candidate would rely on the support or opposition to issues the candidate supports as well as to stance measurement related to the individual politician. Once the system is provided data showing, for example, the full list of presidential candidates, then determining if someone supports one candidate exclusively or more than one candidate affects a determination of stance. In a three-party race, determining if someone supports one candidate, two candidates or three candidates is important to see if their stance is ‘for’ Candidate A. That said, the stance detection system once provided with a list of candidates and ridings and issues and positions, can automate question and converse question generation.

In some situations, such a nuanced system allows the determination of stance strength as well as ‘stance direction’—what is the likelihood of swaying this particular user or this group of users; how loyal is this group of users on this issue?

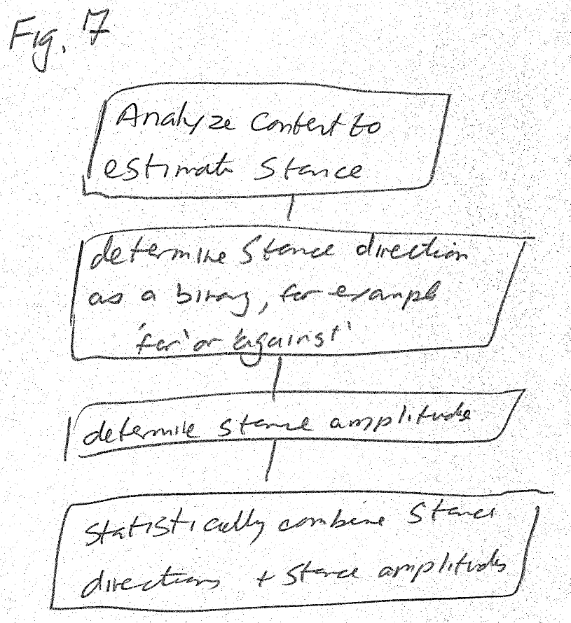

Referring to FIG. 7, shown is a simplified flow diagram of a method of measuring stance that measures stance direction and stance strength. Some content has a defined and absolute stance while other content has some bias toward a stance but is less indicative of the stance than defined and absolute statements. For example, the statement I support Candidate A and will vote for them is different from the statement I don't see any glaring reason not to vote for Candidate A. Thus, a measure of the stance and its strength or amplitude is provided for each stance estimate as determined through semantic analysis.

Once determined, each stance direction and amplitude is statistically combined to estimate stance, either absolutely, or to estimate stance strength. For example one individual is assessed to be supportive of Candidate A while another is leaning toward Candidate A and another is undecided but more for Candidate A than anyone else, etc. Such gradation of stance allows an analyst to group individuals by stance strength and to evaluate actions that will affect stance strength in a direction—where stance direction can be considered positive toward one candidate and negative when it moves toward the other—as intended.

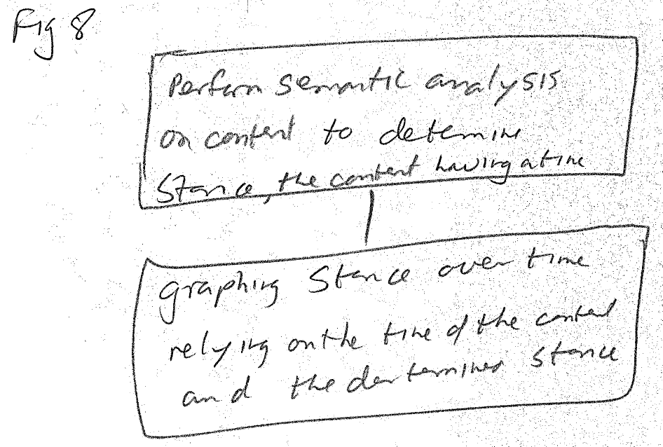

Referring to FIG. 8, shown is a simplified method of mapping stance direction and strength over time. Here stance is evaluated at multiple times, perhaps in relation to known events, and stance strength variations are then seen alongside potential causes. For example, an article comes out in the paper about an affair of Candidate A and the stance strength moves in a direction away from Candidate A. Thus, an analyst can determine that issues of integrity will reduce Candidate A's support amongst supporters. Another article decrying the Candidate's position on taxes is not seen to affect stance strength leading the analyst to evaluate whether the publication was poorly distributed or whether taxes is not an issue that affects stance.

Similarly, Pepsi could monitor stance over time and see what events might affect Pepsi customer loyalty or, alternatively, Coke customers switching to Pepsi.

Numerous other embodiments may be envisaged without departing from the scope of the invention.

What is claimed is:

1. A method comprising:
providing a stance to be determined;
determining a first query indicative of the stance;
determining a second other query indicative of a converse of the stance;
processing semantic analysis of stance for the first query to produce first results;
processing semantic analysis of stance for the second other query to produce second results; and
statistically combining the first results and the second results to determine the stance.

2. A method according to claim 1 wherein the stance is determined for a piece of content.

3. A method according to claim 2 wherein the piece of content is short text message content.

4. A method according to claim 1 wherein the piece of content comprises a social media post.

5. A method according to claim 1 wherein the stance is determined for a user.

6. A method according to claim 5 wherein the stance is determined for a set of users, the set of users selected based on a user-selection criteria and all sharing some common selection criteria.

7. A method according to claim 1 wherein the second query is not affirmed when the first query is affirmed, the second query being a simple negation of the first query.

8. A method according to claim 1 wherein the second query is a query that statistically would not be true when the first query is true but is not a simple negation of the first query.

9. A method according to claim 1 wherein the second query comprises a plurality of queries that as a group statistically would not be true when the first query is true.

10. A method according to claim 9 wherein some queries of the plurality of queries relate to known related issues to the first query.

11. A method according to claim 9 wherein some queries of the plurality of queries relate to known related positions of people ‘for’ the first query.

12. A method comprising:
providing a first stance to be determined;
determining a first query indicative of the first stance;
determining a second other query indicative of a second different stance having a known statistical relation to the first stance; and
processing semantic analysis to determine stance for the first query to provide first results;
processing semantic analysis to determine stance for the second other query to provide second results; and
statistically combining the first results and the second results to determine stance within a piece of content.

13. A method according to claim 12 comprising:
determining a third other query indicative of a third different stance having a known statistical relation to the first stance; and
processing semantic analysis to determine stance for the third other query to provide third results,
wherein statistically combining is performed to statistically combine the first results, the second results and the third results to determine stance within a piece of content.

14. A method according to claim 13 wherein the piece of content is short text message content.

15. A method according to claim 14 wherein the piece of content comprises a social media post.

16. A method according to claim 15 wherein the social media post is a tweet within the Twitter® ecosystem.

17. A method according to claim 12 wherein the stance is determined for a user.

18. A method according to claim 13 wherein the stance is determined for a user.

19. A method according to claim 12 wherein the stance is determined for one of a user and a group of users and wherein the determined stance is then displayed as a time varying graph of the stance of the one of a user and group of users.

20. A method comprising:
providing a first query indicative of a stance to be determined;
determining a second other query related to the stance, a measurement of the a response to the second query statistically indicative of at least some measure of the stance;
processing semantic analysis of stance for the first query to produce first results;
processing semantic analysis of stance for the second other query to produce second results; and
statistically combining the first results and the second results to determine the stance.
